(19) United States
(12) Patent Application Publication
(10) Pub. No.: US 2025/0105249 A1
(43) Pub. Date: Mar. 27, 2025

(54) LGPS-BASED SOLID ELECTROLYTE

(71) Applicants: UNIVERSITY OF MARYLAND, COLLEGE PARK, College Park, MD (US); SK ON CO., LTD., Seoul (KR)

(72) Inventors: Alexander KOZEN, Mt. Rainier, MD (US); Sang Bok LEE, Clarksville, MD (US); Gary W. RUBLOFF, Clarksville, MD (US); Cholho LEE, Yuseonggu (KR); Yang WANG, Bowie, MD (US)

(21) Appl. No.: 18/730,929

(22) PCT Filed: Jan. 21, 2022
(86) PCT No.: PCT/US2022/013364

§ 371 Date: Jul. 22, 2024

(51) Int. Cl. H01M 4/04; H01M 10/0562

(52) U.S. Cl. CPC H01M 4/0471; H01M 10/0562; H01M 2300/0068

(57) ABSTRACT

The present disclosure provides a method for producing a LGPS-based solid electrolyte at a significantly lower temperature and/or time compared to conventional methods. In one particular embodiment, methods disclosed herein include subjecting a material comprising an LGPS-based powder to a pressure of at least 250 MPa at a temperature less than about 450° C. under conditions sufficient to produce the LGPS-based solid electrolyte.

### FIELD

The present disclosure relates to producing a LGPS-based solid electrolyte. In particular, unlike conventional methods, the LGPS-based solid electrolyte assemblies of the present disclosure are produced at a significantly lower temperature and/or time. In one particular embodiment, methods disclosed herein include subjecting a material comprising an LGPS-based powder to a pressure of at least 250 MPa at a temperature of from about 100° C. to about 450° C. under conditions sufficient to produce said LGPS-based solid electrolyte assembly.

### BACKGROUND

With the increasing demand for higher performance solid-state batteries destined to power electric vehicles, and the projection that current technologies cannot meet market demands, there is a rush to develop solid state batteries using lithium metal anodes and high ionic conductivity solid-state electrolytes. While Li metal anodes improve anodic energy density by an order of magnitude over conventional graphite anodes, using Li metal anodes with conventional liquid electrolyte has proven too big of a safety hazard due at least in part to the risk of Li dendrite-related short circuits combined with highly flammable liquid electrolytes.

Li₁₀GeP₂S₁₂ (LGPS) was first developed in 2011 and exhibits the highest reported ionic conductivity demonstrated by any solid-state electrolyte (SSE) material to date, up to 1.2×10⁻² S/cm, surpassing some conventional liquid electrolytes such as 1 M LiPF₆ in conventional carbonate electrolytes (˜1.0×10⁻² S/cm). LGPS powder is commercially available with a grain size of 3 μm. For use as SSE material, LGPS powder is commonly pressed at room temperature into pellets. While “cold” pressing LGPS (i.e., at room temperature) is known to cold-sinter the grains together in the bulk of the pellet, these pellets are not durable enough to be reliably handled and tested using electrochemical cells outside the original pressing die. To improve durability, LGPS pellets are often annealed in argon (Ar) above 500° C. for 2-10 hours prior to final electrochemical cell assembly and testing.

Hot pressing is a well-established technique used for densification of solid ceramic pellets, and in the case of solid electrolytes can form pellets with enhanced mechanical strength and conductivity over their cold-pressed counterparts by reducing grain boundary resistance within the pellets. Hot pressing can result in significantly faster SSE pellet processing times if no subsequent anneal is required. Yi Fei et al., 2018 IOP Conf. Ser.: Mater. Sci. Eng., 394, 022038 (the “Yi Fei et al. Reference”) has reported effects of different sintering temperatures on crystallinity and electric electrochemical properties of the prepared LGPS powder and found that the ionic conductivities of the LGPS samples sintered at 550° C., 560° C., 570° C., 580° C., 590° C. for 8 hours were 0.94 mS/cm, 1.1 mS/cm, 1.6 mS/cm, 0.527 mS/cm, 0.38 mS/cm, respectively. Page 4 of the Yi Fei et al. Reference. Based on these results, the authors concluded that LGPS fabricated at 570° C. has the highest ionic conductivities. Id at page 5. Such a requirement for sintering at high temperature for 8 hours utilizes a large amount of energy and time to produce LGPS SSE materials.

Accordingly, there is a need for a method for producing high quality LGPS SSE materials at a significantly lower temperature and/or shorter time.

### BRIEF SUMMARY

The present disclosure relates to producing a material comprising substantially of LGPS-based solid electrolytes. Unlike conventional methods, the LGPS-based solid electrolyte assemblies of the disclosure are produced at a significantly lower temperature. In some embodiments, methods disclosed herein subject the LGPS-based powder to heat for a significantly shorter time, i.e., about less than 1 h.

Some aspects of the disclosure provide a method for producing a material comprising an LGPS-based solid electrolyte, said method comprising:
subjecting a material comprising an LGPS-based powder to a pressure of at least 250 MPa at a temperature of from about 100° C. to about 450° C. under conditions sufficient to produce said material comprising said LGPS-based solid electrolyte.

In some embodiments, said LGPS-based solid electrolyte comprises the crystalline or amorphous material Li₁₀GeP₂S₁₂, Li₁₀SiP₂S₁₂, LGPS-halide such as Li_{9.54}Si_{1.74}P_{1.44}S_{11.7}Cl_{0.3}, and LiSnP₂SX (where X is halide). As described by Kato et al. (Nature Energy 21 Mar. 2016, 16030, DOI: 10.1038/NENERGY.2016.30.) a family of solid electrolytes with high ionic conductivity is based on sulfide materials with structure related to LGPS (Li₁₀GeP₂S₁₂). This includes various isoelectronic substitutions (e.g., Si or Sn for Ge; N, As, Sb, or Bi for P; O or Se for S) and various stoichiometries of these constituents plus halogens and oxygen. In some instances, said LGPS-halide comprises LGPS-Cl, LGPS-Br, or LGPS-F.

Yet in other instances, said LGPS-based solid electrolyte comprises:
(i) LiₐM_{b}Q_{c}¹Q_{d}² or an oxide or a halide thereof,
wherein
   each of a, b, c, and d is a stoichiometry amount of Li, M, Q¹, and Q²,
      respectively;
   M is Ge, Si or Sn;
   Q¹ is P, N, As, Sb, or Bi; and
   Q² is S, O, or Se;
(ii) Li₁₀SiP₂S₁₂,
(iii) LGPS-halide,
(iv) LiSnP₂SX; or
(v) a combination thereof.
   With regards to a, b, c, and d, in some embodiments a is from 0.1 to about 15, typically from about 5 to about 13, and often from about 9 to about 11; b is from 0.1 to about 2, typically from about 0.5 to about 1.5, and often from about 0.9 to about 1.2; c is from 0.1 to about 5, typically from about 1 to about 3, and often from about 1.8 to about 2.2; and d is from 1 to about 16, typically from about 8 to about 15, and often from about 10 to about 13.

Still in other embodiments, said material comprises a thin film of LGPS-based solid electrolyte, a battery, a monolithic LGPS solid electrolyte pellet, a mixed cathode/electrolyte (catholyte), or anode/electrolyte (anolyte) assembly, or a heterostructured solid electrolyte/current collector sheet.

Yet in other embodiments, said material comprising LGPS-based powder is subjected to a pressure of at least about 300 MPa.

In further embodiments, said material comprising LGPS-based powder is subjected to said temperature for about one hour or less.

Another aspect of the disclosure provides a method for producing a Li₁₀GeP₂S₁₂ (LGPS) solid electrolyte. In this particular aspect of the disclosure, the method comprises applying heat and pressure to LGPS powder under conditions sufficient to produce said LGPS solid electrolyte. The resulting LGPS solid electrolyte has a density of at least about 1.70 g/cm³.

In some embodiments, said LGPS powder is heated to a temperature of from about 100° C. to about 250° C.

Yet in other embodiments, said step of applying heat is conducted prior to said step of applying pressure to said LGPS powder. Still in other embodiments, said step of applying pressure is conducted after said LGPS powder is heated to a desired temperature. In other embodiments, said step of applying heat is conducted for about 1 hour or less.

Still yet in other embodiments, said step of applying heat is conducted for about 30 minutes or less.

In further embodiments, at least about 250 MPa of pressure is applied to said LGPS powder. Still in other embodiments, at least about 300 MPa of pressure is applied to said LGPS powder. Yet in other embodiments, at least about 350 MPa of pressure is applied to said LGPS powder.

Yet another aspect of the disclosure for producing a Li₁₀GeP₂S₁₂ (LGPS) solid electrolyte comprises heating LGPS powder to a temperature of from about 100° C. to about 250° C. and applying a pressure under conditions sufficient to produce said LGPS solid electrolyte.

In some embodiments, said LGPS powder is heated prior to applying said pressure. In other embodiments, at least about 250 MPa of pressure is applied to said LGPS powder. Still, in other embodiments, at least about 300 MPa of pressure is applied to said LGPS powder. Yet in other embodiments, at least about 350 MPa of pressure is applied to said LGPS powder.

Further aspects of the disclosure provide a solid-state electrolyte comprising Li₁₀GeP₂S₁₂ (LGPS) and having a density of at least about 1.70 g/cm³. In some embodiments, said solid-state electrolyte has an ionic conductance of at least about 3×10⁻³ S/cm at room temperature. Yet in other embodiments, density of LGPS is at least about 80%, typically at least about 85%, and often at least about 90% of the theoretical density of LGPS.

Still, further aspects of the disclosure provide a Li₁₀GeP₂S₁₂ (LGPS) solid electrolyte produced by a process comprising heating LGPS powder to a temperature of from about 100° C. to about 250° C. and pressurizing said LGPS powder to at least about 250 MPa to produce said LGPS solid electrolyte. In some embodiments, said LGPS powder is heated for about 1 hour or less. Still in other embodiments, said LGPS is heated to a temperature of from about 100° C. to about 200° C. Yet in other embodiments, said LGPS powder is pressurized to at least about 300 MPa. In further embodiments, a density of said LGPS solid electrolyte is at least about 1.70 g/cm³. Still in other embodiments, said LGPS solid electrolyte has an ionic conductance of at least about 3×10⁻³ S/cm at room temperature.

### BRIEF DESCRIPTION OF THE DRAWINGS

FIG. 1 is SEM cross sectional images of pressed LGPS pellets at (a) 25° C.; (b) 150° C.; (c) 175° C.; and (d) 200° C. along with corresponding surface images of the same LGPS pellets at (e) 25° C.; (f) 150° C.; (g) 175° C.; and (h) 200° C., respectively.

FIG. 2A is EIS spectra of LGPS pellets pressed at 100° C., 150° C., 175° C., and 200° C. in a Li/LGPS/Li configuration.

FIG. 2B is calculated bulk ionic conductivity of LGPS pellets pressed at 100° C., 150° C., 175° C., and 200° C.

FIG. 2C is the calculated density of LGPS pellets pressed at 100° C., 150° C., 175° C., and 200° C.

FIG. 3 shows EIS spectra of three different thicknesses of LGPS pellets pressed at 150° C. with inset showing an equivalent circuit model used for EIS deconvolution.

FIG. 4A shows high resolution XPS spectra of Li1s region comparing cold-pressed LGPS pellets with LGPS pellets exposed to 150° C. for 3 hours at 200 mTorr.

FIG. 4B shows high resolution XPS spectra of Ge3d region comparing cold-pressed LGPS pellets with LGPS pellets exposed to 150° C. for 3 hours at 200 mTorr.

FIG. 4C shows high resolution XPS spectra of P2p region comparing cold-pressed LGPS pellets with LGPS pellets exposed to 150° C. for 3 hours at 200 mTorr.

FIG. 4D shows high resolution XPS spectra of S2p region comparing cold-pressed LGPS pellets with LGPS pellets exposed to 150° C. for 3 hours at 200 mTorr.

FIG. 4E shows high resolution XPS spectra of C1s region comparing cold-pressed LGPS pellets with LGPS pellets exposed to 150° C. for 3 hours at 200 mTorr.

FIG. 4F shows high resolution XPS spectra of O1s region comparing cold-pressed LGPS pellets with LGPS pellets exposed to 150° C. for 3 hours at 200 mTorr.

FIG. 5A is EIS spectra of LGPS pellets hot pressed at 150° C. using CR2032 coin cells with conical springs.

FIG. 5B is EIS spectra of LGPS pellets hot pressed at 150° C. using Swagelok I-cells with nickel foam springs.

FIG. 5C is EIS spectra of LGPS pellets hot pressed at 150° C. using CR2032 coin cells with nickel foam springs.

FIG. 5D is EIS spectra of LGPS pellets hot pressed at 150° C. using MTI split press cell.

FIG. 5E shows average measured ionic conductivity and calculated error for LGPS pellets in each type of cells shown in FIGS. 5A-5D.

FIG. 6A is EIS spectrum of Li| LGPS| NMC cell with catholyte pellet.

FIG. 6B is an expanded view between 0.0 to 0.4 Re(Z) of an initial EIS spectrum of Li| LGPS| NMC cell with catholyte pellet.

FIG. 7 shows galvanostatic charging and discharging profile (V vs. t.) of Li| LGPS| NMC cell with catholyte pellet.

FIG. 8 shows galvanostatic charging and discharging profile (C vs. n.) of Li| LGPS| NMC cell with catholyte pellet.

### DETAILED DESCRIPTION

Solid-state electrolytes are of great interest to the battery community as a replacement for flammable liquid electrolytes. Sulfide-based solid electrolytes, such as Li₁₀GeP₂S₁₂ (LGPS), are one such class of materials with an ionic conductivity rivaling that of liquid carbonate electrolytes. Fabrication processes to produce sulfide solid electrolyte materials generally produce powders or particles with diameters or grain size(s) ranging from a few hundred nm to a few hundred μm. These particles must be mechanically combined to produce solid electrolyte films or pellets. Unfortunately, conventional mechanical die pressing of LGPS powder into pellets for use as solid-state electrolyte (SSE) results in large porosity, low density, and large grain boundary resistance at the solid-solid interface with the electrodes which greatly decreases the performance of LGPS. More significantly, conventional mechanical die pressing of LGPS at room temperature, i.e., about 20° C., leads to poor mechanical stability of such pressed pellets.

The terms “powder” and “particle” typically refer to any solid substance in a state of fine loose particles. To be clear, the terms “powder” and “particles” in the present disclosure refer to solids having grain size or diameter of about 5 mm or less, generally about 1 mm or less, typically about 500 μm or less, and often about 250 μm or less.

Unless the context requires otherwise, the term “solid electrolyte” means a unit of solid material that is used as a solid medium or material that allows facile transport of ions through it while typically retarding the transport of electrons. Solid electrolytes also serve to maintain physical separation between battery or capacitor electrodes and may have various compositions and properties, e.g., from inorganic ceramics like LLZO garnet to flexible organic materials like polymers.

When referring to a numerical value, the terms “about” and “approximately” are used interchangeably herein and refer to being within an acceptable error range for the particular value as determined by one of skilled in the art. Such a value determination will depend at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean±20%, typically ±10%, often ±5%, and more often ±1% of the numerical value. In general, however, where particular values are described in the present application and claims, unless otherwise stated, the term “about” means within an acceptable error range for the particular value, typically within one standard deviation.

As used herein, unless the context requires otherwise “LGPS-based electrolyte” refers to an electrolyte composition comprising any one or more of Li₁₀GeP₂S₁₂, Li₁₀SiP₂S₁₂, LGPS-halide such as Li_{9.54}Si_{1.74}P_{1.44}S_{11.7}Cl_{0.3}, and LiSnP₂SX (where X is halide). As described by Kato et al. a family of solid electrolytes with high ionic conductivity is based on sulfide materials with structure related to LGPS (Li₁₀GeP₂S₁₂). This includes various isoelectronic substitutions (e.g., Si or Sn for Ge; N, As, Sb, or Bi for P; O or Se for S) and various stoichiometries of these constituents plus halogens and oxygen, including those discussed in Kato et al., Nature Energy, 21 Mar. 2016, 16030, DOI: 10.1038/NENERGY.2016.30.

The term “LGPS electrolyte” refers here specifically to Li₁₀MP₂S₁₂, where M is Ge, Si, or Sn, or mixtures thereof. In some embodiments, M is Ge or Si, or mixtures thereof, still in other embodiments, M is Ge or predominantly Ge. The term “predominantly” refers to about 60% or more, typically about 70% or more, often about 80% or more, more often about 90% or more, and most often about 95% or more.

The terms “solid electrolyte,” “solid-state electrolyte,” and “SSE” are used interchangeably herein and refer to pellets or other solid materials that are produced by hot pressing powders and/or particles using methods disclosed herein. Thus, the size of solid electrolyte or SSE is significantly bigger than the size of powders or particles as defined above. Typically, the size or diameter of solid electrolyte or SSE is at least about 100 mm, typically at least about 1 cm, and often at least about 2 cm. However, it should be appreciated that the term “solid electrolyte” in its broadest sense is an operational term and refers to a unit of solid produced by hot pressing the powders and/or particles using methods disclosed herein, and therefore has no size limitations.

As used herein, the size of any powder, particle, or solid refers to the longest or largest dimension or length of the article.

One particular aspect of the disclosure provides the structure and fabrication process that results in densified LGPS-based solid state electrolytes (SSEs) or assemblies of sulfide solid electrolytes or sulfide solid electrolyte composites. Typically, formation of the LGPS-based SSEs involves integrating the solid electrolyte fabrication step(s) with a significantly lower pressing temperature relative to conventional methods to enable densified SSEs, monoliths, or laminated sheets of sulfide solid electrolyte designed for the specific application.

For the sake of clarity and brevity, the present disclosure will now be described with regards to producing LGPS SSEs, namely, Li₁₀GeP₂S₁₂ solid electrolytes. However, it should be appreciated that the scope of the present disclosure is not limited to producing Li₁₀GeP₂S₁₂ solid electrolytes but in general, is applicable to any LGPS-based solid electrolytes. Discussion on producing Li₁₀GeP₂S₁₂ solid electrolyte is provided herein solely for the purpose of illustrating the practice of the disclosure and does not constitute limitations on the scope thereof.

In order to improve mechanical and handling properties, LGPS pellets are often annealed under argon (Ar) at a temperature of above 500° C. for 2-10 hours. For example, as discussed above, the Yi Fei et al. Reference discloses that the ionic conductivities of the LGPS samples sintered at 570° C. for 8 hours had the highest ionic conductivities of 1.6 mS/cm.

Surprisingly and unexpectedly, the present inventors have discovered methods and processes that do not require such a high temperature and pressure to produce LGPS SSEs having excellent mechanical properties and high ionic conductivities. In fact, in some embodiments, such as methods of the present disclosure produce LGPS SSEs having significantly higher ionic conductivities than those disclosed in the Yi Fei et al. reference. Significantly, some aspects of the disclosure are based on the discovery that hot pressing of LGPS at a temperature significantly lower than 500° C., and often at a significantly less time, produces LGPS SSEs having a high density and decreased grain boundary resistance without modifying the constituent material.

While hot pressing temperature can vary depending on many factors, such as but not limited to, time, pressure, and the nature of the LGPS powder, in some embodiments, powder LGPS is hot pressed at a temperature in the range of from about 100° C. to about 500° C., typically from about 100° C. to about 450° C., often from about 100° C. to about 400° C., more often from about 100° C. to about 350° C., still more often from about 100° C. to about 300° C., yet still more often from about 100° C. to about 250° C., and most often from about 100° C. to about 200° C.

The hot-pressing time of LGPS powder to produce LGPS solid electrolytes can also vary depending on a number of factors such as temperature, pressure, and the nature of LGPS powder. In general, methods of the disclosure utilize hot pressing time of about 5 hours or less, typically about 4 hours or less, often about 3 hours or less, more often about 2 hours or less, still more often about 1 hour or less, and most often about 30 minutes or less.

Typically, a sufficient amount of pressure is utilized in producing LGPS solid electrolytes from LGPS powder. The amount of pressure applied should be sufficient enough to produce dense LGPS pellets or LGPS solid electrolytes with decreased grain boundary resistance within the LGPS solid electrolyte itself. While many factors can influence the amount of pressure used, typically pressure of at least about 250 MPa, generally at least about 300 MPa, often at least about 350 MPa is used.

In some embodiments, different pressure is applied to different sections or areas of the LGPS powder. This allows production of LGPS solid electrolytes having a different density pattern(s) within a single LGPS solid electrolyte. For example, by utilizing a press surface having a “waffle” like pattern, or dotted pattern, or a wavy pattern, or ridges, or spikes, or other pattern results in LGPS solid electrolytes with different patterned surfaces. Other exemplary patterns include checkered, chevron, chains, clovers, lattice, link, polka dot, stripe, scales, etc. Such patterning may provide different density (ies) within a single LGPS solid electrolyte and may afford better conductivity and/or decreased boundary resistance within the LGPS solid electrolytes.

Methods of the disclosure produce LGPS SSEs having a high ionic conductivity. The high ionic conductivity of LGPS SSEs produced by methods of the present disclosure make them particularly useful as a replacement for current liquid electrolyte-based Li-ion batteries. For example, Li₁₀GeP₂S₁₂ SSEs produced using methods of the present disclosure have an ionic conductivity of at least about 1×10⁻³ S/cm, typically at least about 2×10⁻³ S/cm, and often at least about 3×10⁻³ S/cm at room temperature.

Still in other embodiments, LGPS SSEs produced using methods disclosed herein have a density of at least about 1.4 g/cm³, typically at least about 1.50 g/cm³, often at least about 1.60 g/cm³, and most often at least about 1.70 g/cm³.

As stated, methods of the present disclosure yield structure and process to achieve densified sulfide solid electrolytes. Moreover, methods disclosed herein allow anode fabrication and passivation processes that can be integrated for efficient manufacturing of LGPS SSEs. Effective passivation of sulfide solid electrolyte pellets or thin films may allow more relaxed purity requirements for battery assembly in dry rooms or more robust battery storage capability.

Another aspect of the disclosure provides a method for producing a material comprising LGPS solid electrolyte. The method includes subjecting a material comprising LGPS powder to a pressure of at least 250 MPa at a temperature of from about 100° C. to about 450° C. under conditions sufficient to produce said material comprising LGPS solid electrolyte.

The material can be an anode or it can be a full-cell battery. Other materials that can be fabricated by methods of the present disclosure include a thin film of LGPS SSEs that can be produced continuously, for example, using a roller or it can be produced batch-wise. In this manner, a long sheet of LGPS SSEs can be produced, which can then be cut into desired sizes and shapes for use as LGPS SSEs in batteries.

Still, in other aspects of the present disclosure, LGPS powder can be mixed with a cathode powder material to produce a cathode-LGPS SSE interface material using methods disclosed herein. Such cathode/LGPS interface material can be a separate material or it can be made as a part of the outer surface of a cathode. Exemplary cathode materials that can be used to produce a cathode/LGPS SSE interface material include, but are not limited to, lithium cobalt oxide, lithium iron phosphate, vanadium oxide, vanadium phosphate, manganese oxide, nickel cobalt oxide, nickel cobalt aluminum oxide, and other metal oxides of various stoichiometries, as well as sulfides and phosphates and other materials that are known to one skilled in the art.

In addition to a cathode powder material and LGPS powder, a binder can also be present in the mixture prior to hot pressing. A binding agent, or binder, is a material used to facilitate formation of a cohesive mixture, e.g., as a means of providing structural stability. Binding agents harden chemically or mechanically, and in the process bind LGPS material and cathode material together to form a solid cohesive material. Exemplary binders or binding agents that can be used in methods disclosed herein include, but are not limited to, polytetrafluoroethylene (PTFE), polyvinylidene fluoride (PVDF), and polyethylene oxide (PEO) as well as other binders known to one skilled in the art. When used, the amount of binder ranges from about 0.1 wt % to about 5 wt %, typically from about 0.1 wt % to about 3 wt %, and often from about 0.1 wt % to about 1 wt %.

Another material that may be added in forming a cathode-LGPS mixture material is a conductive additive material. While not necessary, the presence of conductive additive material may increase an ionic conductance of the resulting cathode-LGPS SSEs. Exemplary conductive additive materials that can be used in methods disclosed herein include, but are not limited to, carbon black (e.g., acetylene black) as forms of high surface area to volume ratios, carbon nanotubes, highly ordered pyrolytic graphite, and graphene nanoflakes, as well as other conductive additive materials known to one skilled in the art. When used, the amount of conductive additive material used ranges from about 0.1 wt % to about 5 wt %, typically from about 0.1 wt % to about 3 wt %, and often from about 0.1 wt % to about 1 wt %.

In another embodiment, LGPS powder can be mixed with an anode powder material to produce an anode-LGPS SSE interface material using methods disclosed herein. Such anode/LGPS interface material can be a separate material or it can be made as a part of the outer surface of an anode. Exemplary anode materials that can be used to produce anode-LGPS SSE interface material include, but are not limited to, graphite or other carbon materials, zinc and zinc alloys, lithium and lithium alloys, sodium and sodium alloys, tin and tin alloys, tin oxide, gold and gold alloys, silver and silver alloys, indium and indium alloys, graphene, carbon nanotubes, and titanium oxide. Other ingredients that may be present include a binder and/or a conductive additive material, such as those described herein.

The LGPS SSEs can be used, for example, as a solid electrolyte in batteries, in particular in all-solid-state batteries. In some embodiments, the battery can be configured to include the following components: cathode|LGPS SSE|anode. In other embodiments, the battery is configured with the following components: cathode|cathode-LGPS interface material|LGPS SSE|anode-LGPS interface material|anode. Alternatively, cathode and cathode-LGPS interface material can be a single solid unit. Similarly, anode and anode-LGPS interface material can be a single solid unit.

In some embodiments, the “all-solid-state battery” is an all-solid-state lithium ion battery. Typically, an all-solid-state battery has a structure in which an LGPS solid electrolyte is arranged between a positive electrode layer and a negative electrode layer. The all-solid-state battery comprising LGPS SSE of the present disclosure can be used in various devices including mobile phones, personal computers, and automobiles.

LPGS SSE can be formed as a film, for example, by placing LPGS powder on a film surface and subjecting the LPGS powder to hot pressing conditions disclosed herein. One can form a roll of LPGS SSE film by rolling the LPGS SSE powder on film while being subjected to the hot press conditions disclosed herein or it can be hot pressed batchwise.

Additional objects, advantages, and novel features of subject matter described in the present disclosure will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### Examples

Commercially available Li₁₀GeP₂S₁₂ (LGPS) powder (MTI Corp.) was pressed into pellets using 0.120 g of powder (unless otherwise specified) at 350 MPa using a hydraulic press and a temperature-controlled die set (range 25° C.-250° C.) with a diameter of 12.7 mm in an Ar-filled glove box (M-Braun). The die was assembled, heated to a desired temperature, and the pressure was applied. Temperature and pressure were maintained for 5 minutes, then the heating program was turned off to let the die set cool and disassembled (<100° C.), while the pressure was maintained for a total pressing time of 45 minutes. To study mechanical and electrochemical characteristics, different pressing temperatures were used including 100° C., 150° C., 175° C. and 200° C. As control, pellets were also pressed at room temperature (20° C.) which is described herein as cold pressed pellets.

SEM images were collected at a beam energy of 10 kV using a Tescan Dual Beam FIB/SEM tool in the Maryland Nanocenter's AIMLab.

Electrochemical cells were assembled using a 12.7 mm diameter split press cell (MTI Corp.). For reactive electrodes, 0.75 mm thick Li ribbon (Alfa Aesar) was cut into 12.7 mm diameter disks with a hand punch, while for non-reactive electrodes 12.7 mm diameter stainless steel disks were used. All cells were assembled symmetrically (electrode| LGPS| electrode) in an Ar-filled glove box (MBraun) for testing. Cells were held under constant pressure (hand tight) by a manual screw press to maintain good electrical contact without breaking the electrolyte pellet. EIS testing was conducted using a Bio-Logic VSP potentiostat with a frequency range from 1 MHz to 10 mHz and a 10 mV amplitude. EIS measurements were processed and compared to simulated electrochemical circuits by EC-lab software using Z-fitting.

XPS spectra were collected using a Kratos Ultra DLD XPS system using monochromated Al Kalpha radiation at 1487 eV. LGPS pellets were transferred directly via UHV transfer from an Ar-filled glovebox to an XPS (Kratos Axis Ultra DLD) system for surface chemical analysis to prevent air exposure. Survey spectra were collected using a 12 kV monochromatic Al Kα X-ray source in hybrid lens mode with a step size of 1 eV and pass energy of 160 eV. High-resolution spectra were collected using a 12 kV monochromatic Al Kα X-ray source in hybrid lens mode with a step size of 0.1 eV and pass energy of 20 eV. No charge neutralization was used. XPS data were analyzed using the CasaXPS software with quantification performed using peak areas normalized by standard photoionization cross sections corrected for our instrument geometry and a Shirley background for all high-resolution peaks.

### Results & Discussion

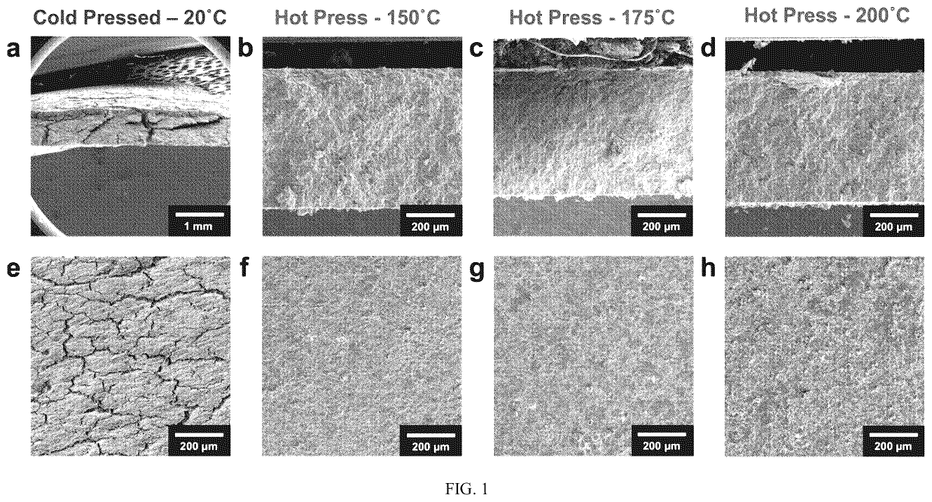

In order to determine the optimal temperature for pressing LGPS pellets, the effect of temperature on the physical and electrochemical properties of the LGPS was studied. SEM cross-sectional images of this temperature series of 150° C., 175° C., and 200° C., compared to cold pressed LGPS pellets, are shown in FIG. 1. Pellets pressed at 20° C. exhibited poor mechanical robustness due to large structural cracks as seen in the SEM images in FIG. 1a along with the corresponding surface image in FIG. 1e. These cold pressed pellets are largely unsuitable for electrochemical testing as they tend to crumble and break with the required handling. Even if the pellets maintain integrity for electrochemical testing, the large cracks result in poor interfacial contact, resulting in large impedances. Second, such large cracks indicate a lack of mechanical strength which might cause the SSE failure under drastic volume change of electrodes during electrochemical cycling. Third, it may provide an easy pathway for the growth of dendrites all the way through the open cracks.

As a comparison, the SEM cross sectional images of three hot pressed pellets in FIGS. 1b, 1c, and 1d, along with their corresponding surface images in FIGS. 1f, 1g, and 1h, respectively, show a dense and compact pellet. These images show that hot pressing of LGPS pellets successfully densifies the structure, forming hot pressed LGPS pellets that are significantly more mechanically stable than their cold pressed counterparts, simplifying handling and subsequent characterization.

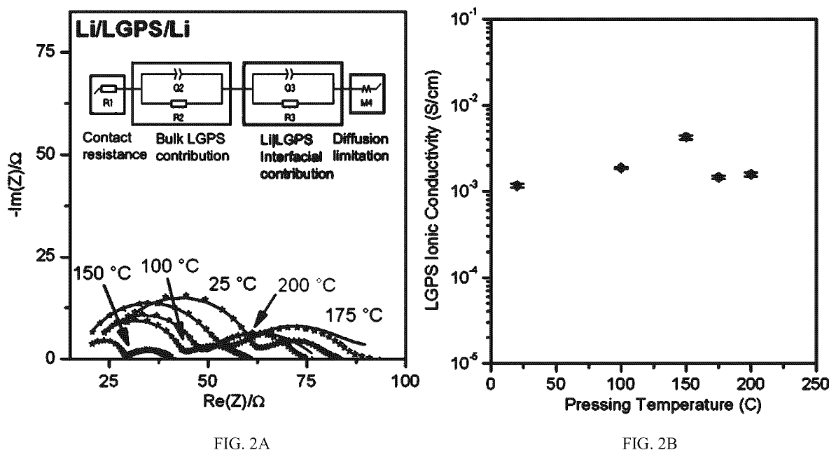

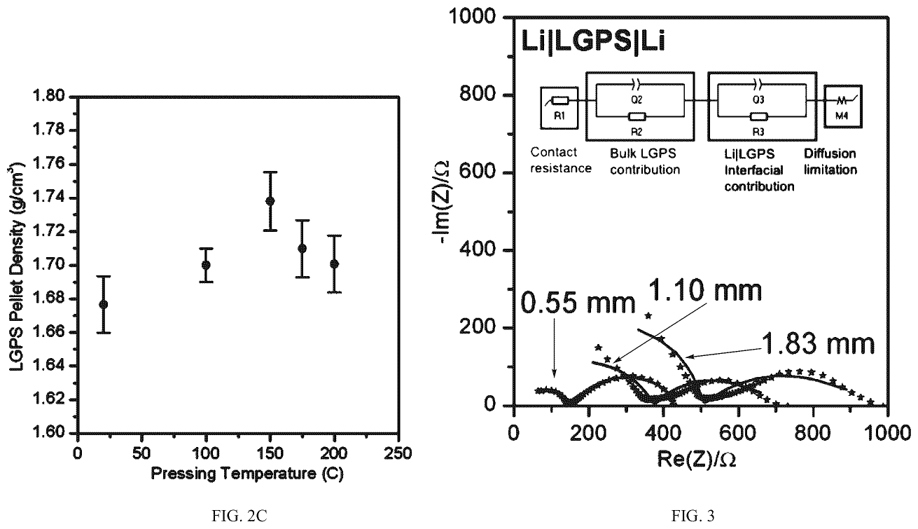

FIG. 2A shows Nyquist EIS plots of LGPS pellets pressed at 20° C., 150° C., 175° C., and 200° C. in a Li|LGPS|Li configuration. The EIS model used for fitting is shown inset in FIG. 2A. For a Li/LGPS/Li symmetric cell configuration, it was expected to consist of the following equivalent circuit components. First, a contact resistance including the resistance of the wires is considered in the cell, where the Li metal and stainless-steel rods are used in the connection of the circuit. Second, the bulk LGPS pellet is modeled as a parallel R/C component. The capacitor in this component can be replaced with a constant phase element (CPE) which better describes a circuit component that models the behavior of an electrical double layer which is a non-ideal capacitor. Therefore, the bulk LGPS can be represented with a parallel R/C or R/CPE circuit unit. Similarly, the interfacial layer made of degradation products of reactions between Li metal and LGPS can also be represented by an additional R/C or R/CPE circuit unit. The equation used for calculating the ionic conductivity, σ, of the bulk LGPS pellet with the simulated impedance is shown in Equation 1:

$$σ = \frac{1}{R} \times \frac{l}{A} \qquad Equation 1$$

where 1 is the length of the pellet and A is the cross-sectional area of the pellet.

Ionic conductivities derived from these EIS data are shown in FIG. 2B. Based on the equivalent circuit model, the calculated ionic conductivity of 20° C. pellet is 1.16×10⁻³ S/cm while the 150° C. pellet is 4.25×10⁻³ S/cm, which is close to the 1.0×10⁻² S/cm theoretical value for LGPS. Clearly, 150° C. is the optimal temperature for hot pressing LGPS pellets. It is believed that such enhancement can be attributed to the densification of the LGPS, shown in FIG. 2C, which leads to better contact within the pellet among LGPS particles. Compared to the theoretical density of LGPS, 1.988 g cm⁻³, the achieved density of LGPS pellets pressed at 20° C., 100° C., 150° C., 175° C. and 200° C., are 84.3%, 85.5%, 87.4%, 86.0%, 85.5% of the theoretical density, respectively. At the same time, the grain boundary impedance is also significantly reduced due to densification during hot pressing, with the highest density LGPS pellets achieved at 150° C.

The reason for the reverse effect of ionic conductivity vs. temperature is not exactly clear, but not uncommon based on previous studies on hot pressing of other materials. First, the increase in temperature may change the crystalline structure of the material and result in an unfavorable structure for the conduction of Li⁺ ions. This is less likely the case for LGPS since the powder is commonly synthesized at a temperature of over 550° C. However, this does not entirely rule out a possibility that under high pressure, such as the 350 MPa, used for pressing, the structure may be more sensitive to temperature changes. Hot pressing serves to densify the LGPS pellets at any temperature, as the most important conclusion drawn from this result is the strong correlation between the calculated ionic conductivity of and the density of the pellets. It is possible that pressing at temperatures above 150° C. may exacerbate cracks, defects, and voids within the bulk LGPS pellet, resulting in lower overall pellet density and effective impedance after cooling to room temperature. These defects can be exacerbated during cycling, resulting in lower electrochemical performance as well.

To confirm EIS equivalent circuit model discussed above and deconvolute the contributions from bulk LGPS and the Li|LGPS interface, cells were fabricated using LGPS pressed at 150° C. with three different pellet thicknesses, 0.55 mm, 1.10 mm, and 1.83 mm, in a Li|LGPS|Li configuration. A Nyquist plot of these data is shown in FIG. 3. Since the same amount of time has elapsed between cell assembly and cell testing, it can be assumed that the interfacial degradation region between Li and LGPS is of similar thickness in all three pellet samples. Thus, the rightmost semicircle (R/Q+M element) is believed to represent the behavior of the Li|LGPS interface and associated reaction byproducts. The leftmost semicircle is thus associated with conduction behavior in the bulk LGPS pellet.

In general, of the various temperatures studied, 150° C. was determined to be the preferred pressing temperature for both the enhanced ionic conductivity and densified structure. The difference in overall impedance between pellets pressed at 150° C. and those pressed at higher temperatures is minimal, but the increased time and associated lower throughput with increasing temperature (largely due to die cooling time) do not justify increasing the pressing temperature any higher than necessary.

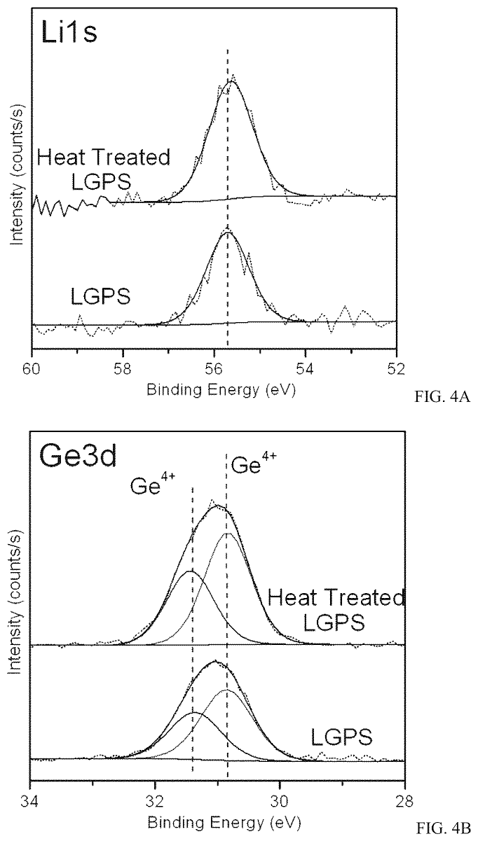

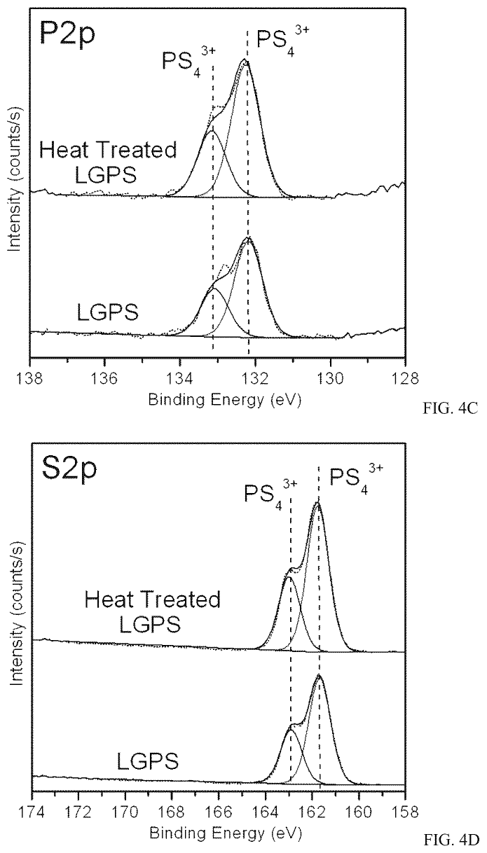

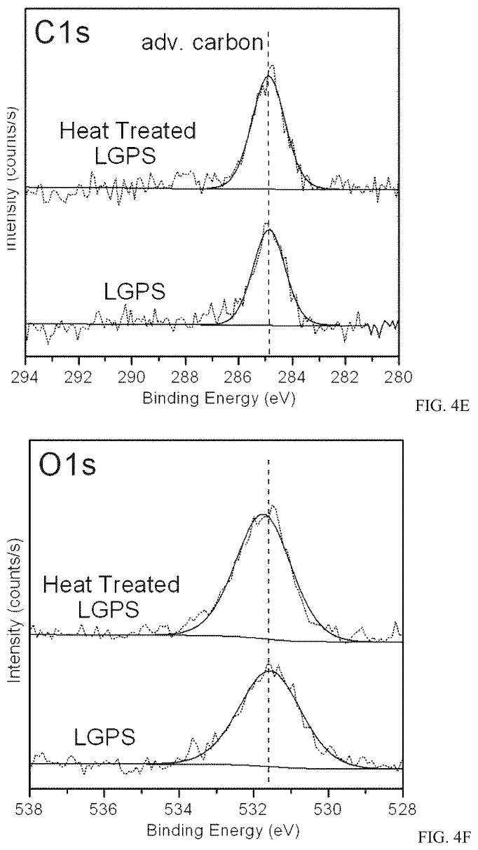

In order to determine whether the improved ionic conductivities measured were due to mechanical improvements and/or chemical changes on the surface of the pellets during the LGPS hot pressing process, XPS was used to measure the surface of the as-pressed pellets (without air exposure). FIGS. 4A-4F show high resolution XPS spectra of various regions comparing LGPS pellets pressed at 20° C. and 150° C. Notably, there are no identifiable chemical changes to the LGPS surface after the hot pressing procedure at 150° C., indicating that hot pressing is a purely mechanical process without inducing any chemical changes to the LGPS. In contrast, LGPS pellets heat treated at 250° C. showed some surface oxidation but no chemical changes to the LGPS, and notably, there is no evidence of Ge oxidation (data not shown). FIG. 4A shows the Li1s high resolution peak, where there are no identifiable peak shifts due to surface oxidation. The Li1s peak is relatively insensitive to chemical peak shifts, and as such is generally not suitable for chemical identification alone. The Ge 3d peak, shown in FIG. 4B, is consistent with Ge⁴⁻ bonding both before and after heat treatment, indicative of LGPS. Both the P2p region, shown in FIG. 4C, and the S2p region, shown in FIG. 4D, are consistent with PS₄³⁻type bonding, also indicative of LGPS. Notably, the S₂p region shows only peaks associated with S-bridging with no evidence of S—S, S—O, or Li₂S bonding. The C1s region, shown in FIG. 4E, indicates that carbon species present are adventitious, likely adsorbed onto the sample surface in the glovebox during pellet pressing, but also precluding formation of carbonate species on the LGPS surface. The O1s peak, FIG. 4F, is remarkably broad, indicating a mixed-binding environment consistent with surface oxygen contamination, and at <2% of the composition is comparable to other XPS studies of LGPS. While XPS only samples the top ˜10 nm of the LGPS pellet, due to the heating of the pressing die any chemical changes would likely occur at this interface first before propagating to the bulk of the pellet.

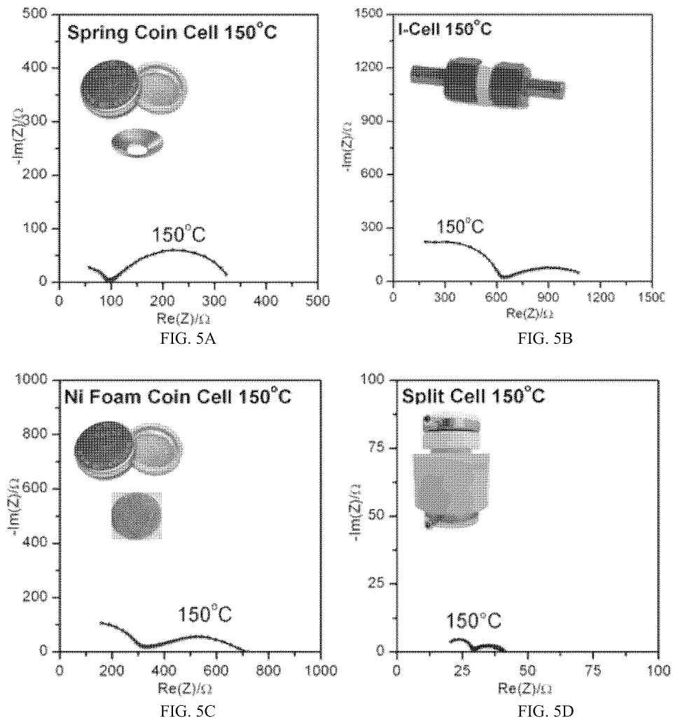

In addition to optimizing the mechanical robustness of the LGPS pellets, EIS of LGPS pellets in a Li|LGPS|Li configuration were also measured to determine which testing cells are the most suitable for electrochemical measurements. Four different types of cells were compared, and each result is averaged over a minimum of 3 different cells. Examples of EIS spectra measured from coin cells with conical springs (FIG. 5A), coin cells with Ni foam springs (FIG. 5B), Swagelok I-cells (FIG. 5C), and MTI compression cells (FIG. 5D) show a large variation in both shape and features. Using the same EIS model as described above, the bulk LGPS ionic conductivity were measured for each cell type, plotted in FIG. 5E. The reliability of both coin cell types is not ideal due to variable contact and the propensity of LGPS pellets to break in this testing configuration, demonstrated by the large error bars shown with two of these cell types. Cells that are assembled by hand however demonstrate greater reliability and lower variability in measured ionic conductivities. However, the Swagelok-I cells do not undergo continuous compression during testing; they were assembled by hand and then tested without any compression. This can result in poor interfacial contact and also poor contact within the pellet itself. The MTI split cell, which was tested under continuous compression applied by a screw press, solved these issues, and the data from these split cells clearly demonstrate lowest interfacial and bulk impedances, but also exhibit the smallest cell to cell measurement variability. The continuous pressure applied to the split cell is also essential to its success by maintaining good contact between the disparate parts of the testing cell during volumetric changes during lithium stripping and plating. Excess pressure during testing beyond that needed to achieve good cell contact was not found to appreciably impact electrochemical results.

### SUMMARY

The present disclosure clearly demonstrates the use of hot pressing to produce mechanically robust LGPS pellets with negligible chemical degradation. In addition, the present disclosure also demonstrates that hot pressing results in pellet densification only and exhibits the associated improvement in ionic conductance. These standalone LGPS pellets were tested using multiple cell testing apparatus to compare and interpret electrochemical results. The measured ionic conductance and calculated ionic conductivity values of LGPS pellets correlate directly with the density of the pellets, demonstrating the importance of hot pressing to improve pellet densities. It was also discovered that pressing temperature utilized in this disclosure does not induce chemical changes to the LGPS pellets thus the change in ionic conductivity of the pellets is not propelled by chemical changes. Furthermore, it was determined that the measured ionic conductance of the LGPS pellets is influenced by the configurations of testing cells, among which the split compression cells demonstrated the most reliability and reproducibility of testing results. Significantly, the present disclosure demonstrates that LGPS pellet densification is important to realize near-theoretical ionic conductivities and improve pellet handling and testing.

### NMC| LGPS Catholyte| Electrolyte Hybrid Full Cell Assembly

Fabrication: NMC-811 powder: LGPS powder: VGCF (vapor grown carbon fiber): PTFE (binder) were mixed in a weight ratio of 80:20:3:0.5 and ground by hand for 10 min using a mortar and pestle. LGPS powder (0.12 g) was put in the bottom layer, and 0.10 g of mixture powder was placed on top of LGPS powder layer without subsequent mixing. The two layers were pressed into a single 0.5 inch (˜1.25 cm) in diameter pellet using the previously described hot pressing protocol at 300 MPa, 150° C. for 50 min.

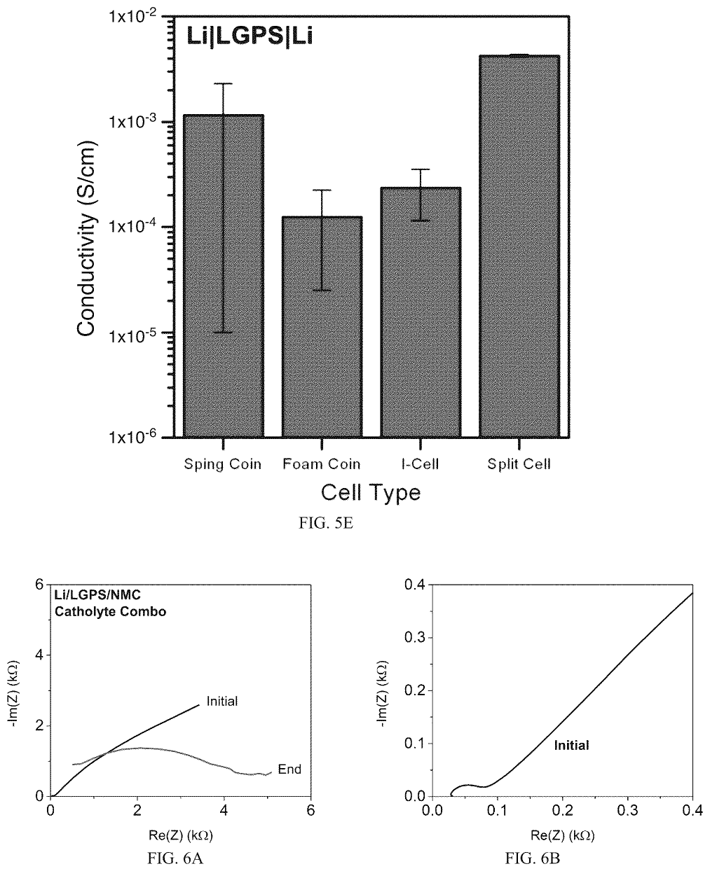

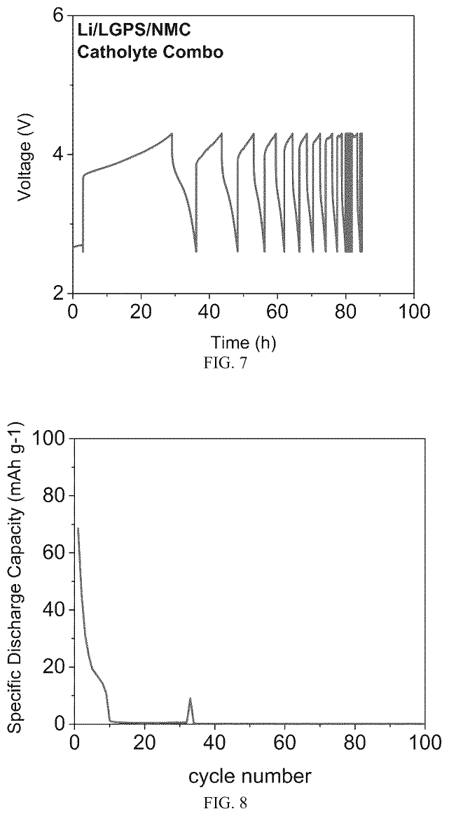

Electrochemical Testing: Li| LGPS| NMC sandwiches were closed in split compression cells. Stainless steel disks were used as current collectors. EIS (electrochemical impedance spectroscopy)+100 cycles of galvanostatic charging and discharging+EIS testing was run on a Bio-logic potentiostat. FIGS. 6A and 6B. EIS was scanned from 1 MHz to 10 MHz at a 10 mV perturbation voltage. Galvanostatic charging and discharging was done by cycling between 2.6 V to 4.2 V (vs. Li⁺/Li) at 0.1 mA/cm² current density. FIGS. 7 and 8. The electrochemical testing data was analyzed with EC-lab software.

### Results & Discussion

Li₁₀GeP₂S₁₂ is a superionic conductor that has an ionic conductivity matching conventional liquid electrolytes (10⁻³ S cm⁻¹). As can be seen in the above example, batteries produced using LGPS SSEs disclosed herein showed none of the disadvantages of the conventionally produced LGPS SSEs, such as a relatively high porosity, low density, and large grain boundary resistance at the solid-solid interface with the electrodes which greatly decrease the performance of LGPS in addition to poor mechanical stability of such pressed pellets. Use of hot press method disclosed herein results in LGPS SSE pellets that have a high density, and a high ionic conductance. In addition, XPS showed there is no observable chemical degradation of the LGPS powder during the hot pressing process disclosed herein.

The foregoing discussion of the subject matter of the present disclosure has been presented for purposes of illustration and description. The foregoing is not intended to limit the scope of the present disclosure to the form or forms disclosed herein. Although the description of the subject matter of the present disclosure includes the description of one or more embodiments and certain variations and modifications, other variations and modifications are within the scope of the present disclosure, e.g., as may be within the skill and knowledge of those in the art, after understanding the present disclosure. It is intended to obtain rights, which include alternative embodiments to the extent permitted, including alternate, interchangeable, and/or equivalent structures, functions, ranges or steps to those claimed, whether or not such alternate, interchangeable, and/or equivalent structures, functions, ranges or steps are disclosed herein, and without intending to publicly dedicate any patentable subject matter. All references cited herein are incorporated by reference in their entirety.

1. A method for producing a material comprising an LGPS-based solid electrolyte, said method comprising:
subjecting a material comprising LGPS-based powder to a pressure of at least 250 MPa at a temperature of from about 100° C. to about 450° C. under conditions sufficient to produce said material comprising said LGPS-based solid electrolyte.

2. The method of claim 1, wherein said LGPS-based solid electrolyte comprises:
(i) LiₐM_{b}Q_{c}¹Q_{d}² or an oxide or a halide thereof,
wherein
each of a, b, c, and d is a stoichiometry amount of Li, M, Q¹, and Q², respectively;
M is Ge, Si, or Sn;
Q¹ is P, N, As, Sb, or Bi; and
Q² is S, O, or Se;
(ii) Li₁₀SiP₂S₁₂,
(iii) LGPS-halide,
(iv) LiSnP₂SX; or
(v) a combination thereof.

3. The method of claim 2, wherein said LGPS-halide comprises LGPS-Cl or LGPS-F.

4. The method of claim 1, wherein said material comprises a thin film of LGPS-based solid electrolyte.

5. The method of claim 1, wherein said material comprising LGPS-based powder is subjected to a pressure of at least about 300 MPa.

6. The method of claim 1, wherein said material comprising LGPS-based powder is subjected to said temperature for about one hour or less.

7. A method for producing a Li₁₀GeP₂S₁₂ (LGPS) solid electrolyte, said method comprising applying heat and pressure to LGPS powder under conditions sufficient to produce said LGPS solid electrolyte, wherein said LGPS solid electrolyte has a density of at least about 1.70 g/cm³.

8. The method of claim 7, wherein said LGPS powder is heated to a temperature of from about 100° C. to about 250° C.

9. The method of claim 7, wherein said step of applying heat is conducted prior to said step of applying pressure to said LGPS powder.

10. The method of claim 7, wherein said step of applying pressure is conducted after said LGPS powder is heated to a desired temperature.

11. (canceled)

12. The method of claim 7, wherein said step of applying heat is conducted for about 30 minutes or less.

13-14. (canceled)

15. The method of claim 7, wherein at least about 350 MPa of pressure is applied to said LGPS powder.

16-20. (canceled)

21. A solid-state electrolyte comprising Li₁₀GeP₂S₁₂ (LGPS) and having a density of at least about 1.70 g/cm³.

22. The solid-state electrolyte of claim 21, wherein said solid-state electrolyte has an ionic conductance of at least about 3×10⁻³ S/cm at room temperature.

23. The solid-state electrolyte of claim 21, wherein said density of LGPS is at least about 85% of the theoretical density of LGPS.

24. The solid-state electrolyte of claim 21, wherein said solid-state electrolyte is produced by a process comprising heating LGPS powder to a temperature of from about 100° C. to about 250° C. and pressurizing said LGPS powder to at least about 250 MPa to produce said LGPS solid electrolyte.

25. The solid-state electrolyte of claim 24, wherein said LGPS powder is heated for about 1 hour or less.

26. The solid-state electrolyte of claim 24, wherein said LGPS is heated to a temperature of from about 100° C. to about 200° C.

27. The solid-state electrolyte of claim 24, wherein said LGPS powder is pressurized to at least about 300 MPa.

28-29. (canceled)
